(19) United States
(12) Patent Application Publication
(10) Pub. No.: US 2015/0337871 A1
(43) Pub. Date: Nov. 26, 2015

(54) HYDRAULIC CONTROL SYSTEM HAVING BIAS CURRENT CORRECTION

(71) Applicant: Caterpillar Inc., Peoria, IL (US)

(72) Inventor: Hongliu Du, Naperville, IL (US)

(73) Assignee: Caterpillar Inc., Peoria, IL (US)

(21) Appl. No.: 14/285,998

(22) Filed: May 23, 2014

(51) Int. Cl. F15B 13/044; F15B 19/00; F15B 11/08

(52) U.S. Cl. CPC F15B 13/044; F15B 11/08; F15B 19/00; F15B 2211/405; F15B 2211/63

(57) ABSTRACT

A hydraulic control system for a machine is disclosed. The hydraulic control system may include a pump configured to pressurize fluid, a displacement control valve configured to affect displacement of the pump, and a solenoid configured to bias the displacement control valve to a zero position. The hydraulic control system may also include a controller in communication with the solenoid. The controller may be configured to estimate a bias current that biases the displacement control valve to the zero position, and to control the displacement control valve based on the bias current. The controller also be further configured to monitor a pump parameter of the pump, and to determine a control error associated with the pump parameter. The controller may further be configured to selectively adjust the bias current based on the control error.

### TECHNICAL FIELD

The present disclosure relates generally to a hydraulic control system and, more particularly, to a hydraulic control system having bias current correction.

### BACKGROUND

Variable displacement hydraulic pumps are commonly used to provide adjustable fluid flows to machine hydraulic actuators, for example, to cylinders or motors associated with moving machine tools or linkage. Based on a demand of the actuators, the displacement of the pump is either increased or decreased such that the actuators move the tools and/or linkage at an expected speed and/or with an expected force, in some applications, the displacement of the pump is controlled by way of a displacement control valve that is connected to a displacement actuator of the pump. During steady state conditions, the pump displacement control valve may be biased to its zero-position.

One example of pump displacement control is described in U.S. Pat. No. 8,596,057 (the '057 patent) issued to Du on Dec. 3, 2013. Specifically, the '057 patent describes an apparatus for controlling a variable displacement hydraulic pump. The apparatus includes a control actuator operable to control an angle of the pump's swashplate, a three-way control valve connected to the control actuator, and a solenoid configured to move a spool of the three-way control valve between a flow passing position that allows fluid to flow between a charge pump and the control actuator, and a flow blocking position that prevents fluid from flowing between the charge pump and the control actuator. During steady state conditions, the solenoid is energized to bias the control valve to the flow blocking position, or zero (null) position. By biasing the control valve to the flow blocking position, precise manipulation of the swashplate angle can be achieved more stably.

Although the apparatus of the '057 patent may help increase precision regulation of pump displacement, certain disadvantages may still persist. For example, the apparatus may not account for variances in the control valves and in pump actuators due to inconsistencies in manufacturing tolerances. As a result, displacement accuracy, stability, and response time of the apparatus may still be less than desired.

The disclosed hydraulic control system is directed to overcoming one or more of the disadvantages set forth above and/or other problems of the prior art.

### SUMMARY

In one aspect, the present disclosure is directed toward a hydraulic control system. The hydraulic control system may include a pump configured to pressurize fluid, a displacement control valve configured to affect displacement of the pump, and a solenoid configured to bias the displacement control valve to a zero position. The hydraulic control system may also include a controller in communication with the solenoid. The controller may be configured to estimate a bias current that biases the displacement control valve to the zero position, and to control the displacement control valve based on the bias current. The controller also be further configured to monitor a pump parameter of the pump, and to determine a control error associated with the pump parameter. The controller may further be configured to selectively adjust the bias current based on the control error.

In another aspect, the present disclosure is directed toward a method for controlling fluid flow from a pump. The method may include estimating a bias current required to control displacement of the pump, and controlling the pump based on the estimated bias current. The method may also include monitoring a pump parameter of the pump, and determining a control error associated with the monitored pump parameter. The method may further include selectively adjusting the estimated bias current based on the control error.

In yet another aspect, the present disclosure is directed toward a machine. The machine may include a power source, and a pump driven by the power source to pressurize fluid. The machine may also include a tool, a hydraulic actuator configured to move the tool, and a displacement control valve configured to affect displacement of the pump. The machine may further include a solenoid configured to bias the displacement control valve to a zero position, and a controller in communication with the solenoid. The controller may be configured to estimate a bias current that biases the displacement control valve to the zero position, and control the displacement control valve based on the bias current. The controller may also be configured to monitor a pump parameter of the pump, and determine a control error associated with the pump parameter. The controller may further be configured to make a comparison between the control error and a predetermined error, and selectively adjust the bias current based on the comparison

### BRIEF DESCRIPTION OF THE DRAWING

FIG. 1 is a pictorial illustration of an exemplary disclosed machine;

FIG. 2 is a schematic illustration of an exemplary disclosed hydraulic control system that may be used with machine of FIG. 1;

FIG. 3 is a cross sectional illustration of an exemplary disclosed control valve that may be used with the hydraulic control system of FIG. 2; and

FIG. 4 is a flow diagram illustrating an exemplary bias current correction process performed by the hydraulic control system of FIG. 2.

### DETAILED DESCRIPTION

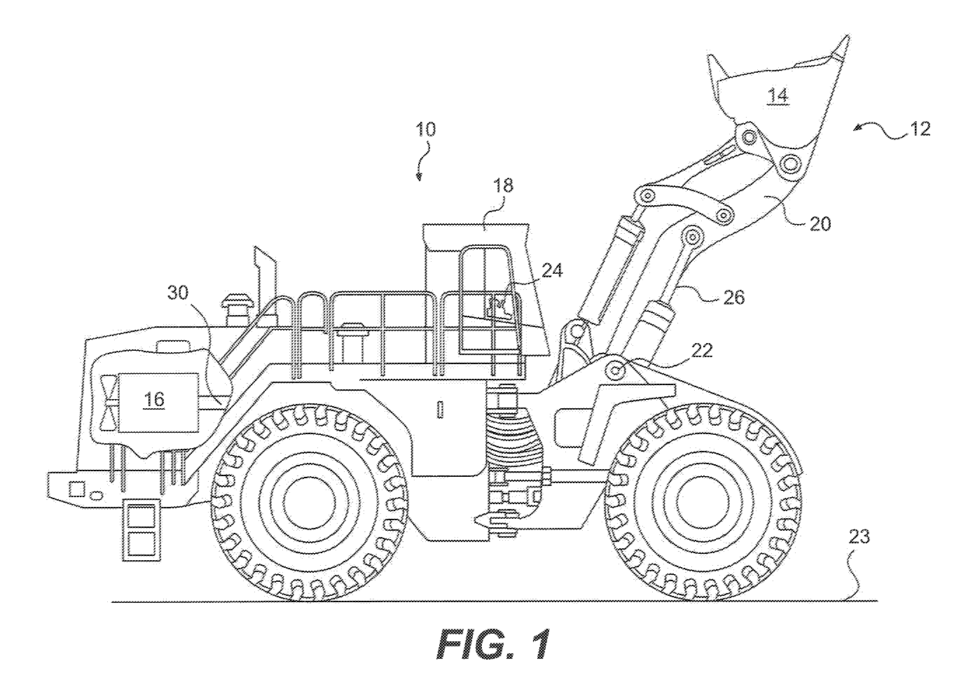

An exemplary embodiment of a machine 10 is illustrated in FIG. 1. Machine 10 may be a mobile or stationary machine capable of performing an operation associated with a particular industry. For example, machine 10 is shown in FIG. 1 configured as a front loader used in the construction industry. It is contemplated, however, that machine 10 may be adapted to many different applications in various other industries such as transportation, mining, farming, or any other industry known to one skilled in the art. Machine 10 may include an implement system 12 configured to move a work tool 14, a power source 16 that provides power to implement system 12, and an operator station 18 for manual and/or automatic control of implement system 12.

Implement system 12 may include a linkage structure acted on by one or more fluid actuators to move work tool 14. In the disclosed example, implement system 12 includes a boom member 20 vertically pivotal about a horizontal axis 22 relative to a work surface 23 by one or more hydraulic actuators 26 (only one shown in FIG. 1), for example one or more cylinders and/or motors. Boom member 20 may be connected to work tool 14 such that activation (e.g., extension and/or retraction) of hydraulic actuators 26 functions to move work tool 14 in a desired manner. It is contemplated that implement system 12 may include different and/or additional linkage members and/or hydraulic actuators than depicted in FIG. 1, if desired.

Work tool 14 may include a wide variety of different implements such as, for example, a bucket, a fork, a drill, a traction device (e.g., a wheel), or any other implement apparent to one skilled in the art. Movement of work tool 14 may be affected by hydraulic actuators 26, which may be manually and/or automatically controlled from operator station 18.

Operator station 18 may be configured to receive input from a machine operator indicative of a desired work tool movement. Specifically, operator station 18 may include one or more operator interface devices 24 embodied as single or multi-axis joysticks located proximal an operator seat. Operator interface devices 24 may be proportional-type controllers configured to position, orient, and/or activate work tool 14 by producing a work tool position signal that is indicative of a desired work tool velocity and/or force. In some examples, the signals from operator interface devices 24 may be used to regulate a flow rate, a flow direction, and/or a pressure of fluid within hydraulic actuators 26, thereby controlling a speed, a movement direction, and/or a force of work tool 14. It is contemplated that different operator interface devices may alternatively or additionally be included within operator station 18 such as, for example, wheels, knobs, push-pull devices, switches, pedals, and other operator interface devices known in the art.

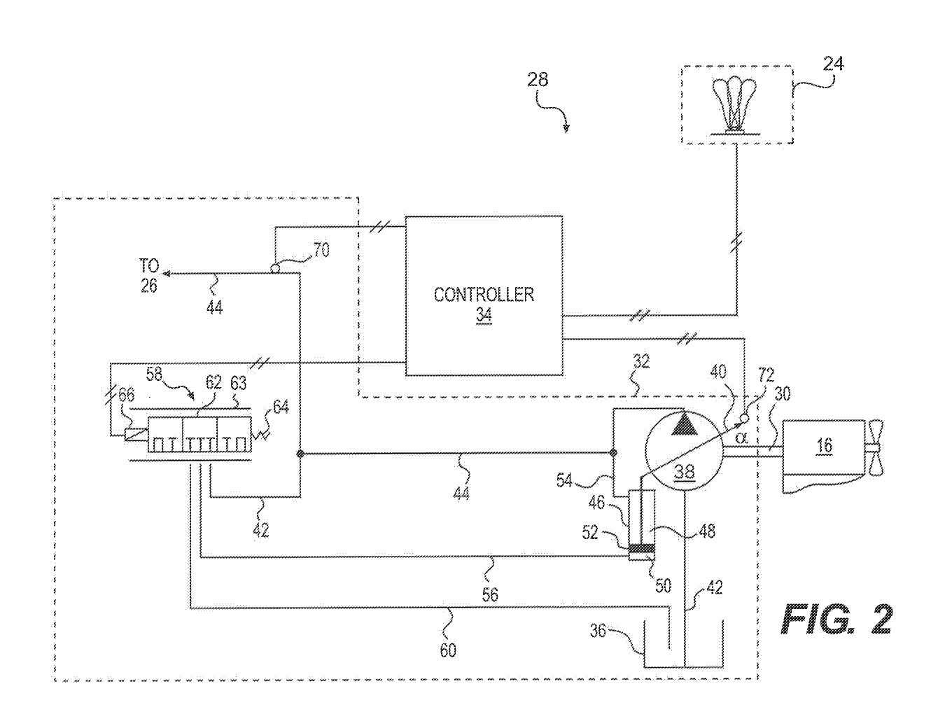

Referring to FIG. 2, power source 16 may be associated with a hydraulic control system 28 that regulates activation of hydraulic actuators 26. Power source 16 may be configured to provide substantially constant power (torque and/or rotational speed) to hydraulic control system 28 by way of a shaft 30. Alternatively, power source 16 may be connected to power hydraulic control system 28 using various other methods such as a gear, a belt, a chain, an electrical circuit, or by any other method known in the art.

Hydraulic control system 28 may include a hydraulic circuit 32, and a controller 34 situated to control fluid flow through hydraulic circuit 32. Hydraulic circuit 32 may itself consist of various fluid components used to direct the flow of pressurized fluid within hydraulic control system 28. For example, hydraulic circuit 32 may include a supply 36 of hydraulic fluid, a pump 38 driven by power source 16 to pressurize the hydraulic fluid, and hydraulic actuators 26 that utilize the pressurized fluid to move work tool 14 (referring to FIG. 1). Controller 34 may communicate with pump 38, hydraulic actuators 26, and/or power source 16 to selectively move work tool 14 according to signals from operator interface device 24.

Pump 38 may generally embody a variable displacement pump having a displacement control device 40. In one example, pump 38 may be an axial piston-type pump equipped with a plurality of pistons (not shown) that may be caused to draw fluid from supply 36 via a passage 42 and to discharge the fluid at elevated pressures to a supply passage 44. In this example, displacement control device 40 may be a swashplate upon which the pistons slide. As the pistons are rotated relative to the swashplate, a tilt angle α of the swashplate may cause the pistons to reciprocate within their bores and generate the pumping action described above. In this manner, the tilt angle α of displacement control device 40 may be directly related to a displacement amount of each piston and, subsequently, to a total displacement of pump 38. The pressurized fluid discharged from pump 38 to supply passage 44 may be selectively directed to move hydraulic actuators 26 by way of a tool control valve (not shown).

A tilt actuator 46 may be associated with displacement control device 40 to affect tilt angle α. In one example, tilt actuator 46 may be a hydraulic cylinder having a first chamber 48 separated from a second chamber 50 by way of a piston assembly 52. First chamber 48 may be in continuous communication with the discharge pressure of supply passage 44 via a first chamber passage 54, while second chamber 50 may be selectively communicated with the discharge pressure and with a lower pressure of supply 36 via a second chamber passage 56.

Piston assembly 52 may be mechanically connected to displacement control device 40 to move displacement control device 40 in response to a force differential across piston assembly 52 caused by fluid pressures within first and second chambers 48, 50. For example, as second chamber 50 is drained of fluid (i.e., fluidly communicated with the lower pressure of supply 36), piston assembly 52 may be caused to retract and thereby increase tilt angle α, in contrast, as second chamber 50 is filled with pressurized fluid (i.e., fluidly communicated with the discharge pressure of supply passage 44), piston assembly 52 may be caused to extend and thereby reduce tilt angle α. In this configuration, an amount of fluid within second chamber 50 may be related to a position of displacement control device 40, while a rate of fluid flow into and out of second chamber 50 may be related to a velocity of displacement control device 40 and hence a rate of displacement change of pump 38. It is contemplated that the above description of filling and draining of first and second chambers 48, 50 relative to the retraction and extension of piston assembly 52 may be reversed, if desired. It is further contemplated that piston assembly 52 and/or displacement control device 40 may be spring-biased toward a particular displacement position, for example toward a minimum or a maximum displacement position, if desired.

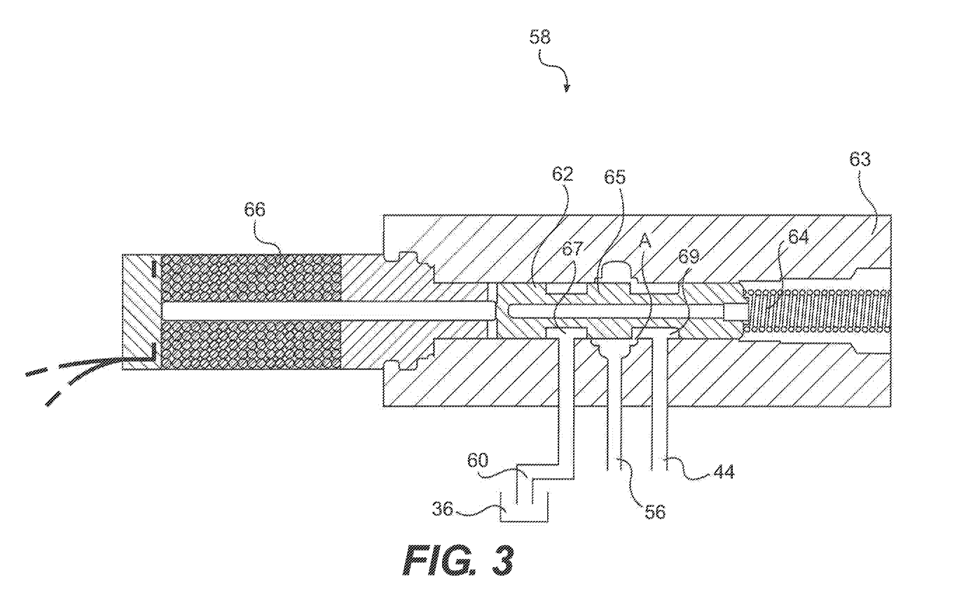

A displacement control valve 58 may be situated in communication with supply passage 44, with second chamber passage 56, and, via a drain passage 60, with supply 36 to control the flow of fluid to and from second chamber 50. Displacement control valve 58 may be one of various types of control valves including, for example, a proportional-type solenoid valve. As shown in both FIGS. 2 and 3, displacement control valve 58 may include a valve element 62 slidably disposed within a body 63 and movable against the bias of a spring 64 to any position between three distinct operating positions by way of a solenoid 66. Solenoid 66 may be selectively energized by controller 34 to move valve element 62 to any desired position.

In one embodiment, shown in FIG. 3, valve element 62 may be a spool having at least one land 65 separating a first annular recess 67 from a second annular recess 69. First annular recess 67 may be in continuous fluid communication with drain passage 60, while second annular recess 69 may be in continuous fluid communication with supply passage 44. In a first position (shown in FIG. 2), land 65 may substantially block fluid flow between supply passage 44 and second chamber passage 56 via second annular recess 69, and between second chamber passage 56 and drain passage 60 via first annular recess 67. In the first position, no adjustment of tilt angle α may occur (i.e., piston assembly 52 may be substantially hydraulically locked from moving displacement control device 40). For the purposes of this disclosure, the first position may be referred to as a zero position or a null position of displacement control valve 58.

From the first position shown in FIG. 2, solenoid 66 may be selectively energized to linearly translate valve element 62 to the right to achieve the second position (not shown). In the second position, first annular recess 67 of valve element 62 may connect second chamber passage 56 with drain passage 60, thereby allowing fluid to flow from second chamber 50 to supply 36, effectively depressurizing second chamber 50. In this position, high-pressure fluid in first chamber 48 may cause piston assembly 52 to retract and thereby increase the tilt angle α of displacement control device 40.

From the first position shown in FIG. 2, solenoid 66 may be selectively energized to move valve element 62 to the left to achieve the third position (shown in FIG. 3). In the third position, second annular recess 69 may connect second chamber passage 56 with supply passage 44, thereby allowing discharge fluid to flow from pump 38 to second chamber 50, effectively pressurizing second chamber 50. In this position, high-pressure fluid in second chamber 50, combined with a greater effective cylinder area on piston assembly 52, may cause piston assembly 52 to extend and thereby decrease the tilt angle α of displacement control device 40.

When valve element 62 is moved to a position between the first and second positions or to a position between the first and third positions, piston assembly 52 may still move to increase or decrease the tilt angle α, but may do so at a speed proportional to the position of valve element 62. That is, it is contemplated that fluid flowing through first annular recess 67 and/or through second annular recess 69 may flow at a rate proportional to an effective valve area Aᵥₐₗᵥₑ of the corresponding annular recess 67, 69. As used herein, Aᵥₐₗᵥₑ may refer specifically to the smallest area through which fluid passes within displacement control valve 58.

During operation of pump 38, leakage between supply passage 44, second chamber passage 56, and/or drain passage 60 may cause valve element 62 to move to undesired positions. For example, during steady state conditions (e.g., conditions where constant discharge pressure P and/or tilt angle α is desired), the leakage may cause valve element 62 to move from the zero position to the positions between the first and second positions or the first and third positions, thereby affecting the discharge pressure P and/or tilt angle α. To compensate for the leakage, displacement control valve 58 may be biased to its zero-position. In particular, solenoid 66 may be selectively energized with a bias current to move valve element 62 to the zero position in response to the leakage. In conditions where a desired change to discharge pressure P and/or tilt angle α is requested, solenoid 66 may be selectively energized with the bias current plus a current required to move valve element 62 to its desired position, such that tilt actuator 46 adjusts the tilt angle α of displacement control device 40 to obtain the request change. As a result, precise control over the discharge pressure P and/or tilt angle α may still be achieved in situations where leakage is present.

One or more sensors may be associated with controller 34 to facilitate precise control over the discharge pressure P and/or tilt angle α. In particular, a first sensor 70 may be located to monitor the discharge pressure of pump 38, for example a pressure of fluid within supply passage 44 upstream of the tool control valve associated with hydraulic actuators 26. A second sensor 72 may be located to monitor the tilt angle α of the swashplate. Sensors 70, 72 may be configured to generate signals indicative of the monitored values, and send these signals to controller 34 for processing.

As will be described in greater detail below, in response to input from sensors 70, 72 and/or from operator interface device 24, controller 34 may adjust operation of control valve 58 to affect movement of tilt actuator 46. Controller 34 may embody a single microprocessor, or multiple microprocessors that include a means for controlling and operating components of hydraulic control system 28. Numerous commercially available microprocessors may be configured to perform the functions of controller 34. It should be appreciated that controller 34 could readily embody a general microprocessor capable of controlling numerous machine functions. Controller 34 may include a memory, a secondary storage device, a processor, and any other components for running an application. Various other circuits may be associated with controller 34 such as a power supply circuit, a signal conditioning circuit, a solenoid driver circuit, and other types of circuits.

One or more maps relating various system parameters may be stored in the memory of controller 34. Each of these maps may include a collection of data in the form of tables, graphs, equations and/or another suitable form. The maps may be automatically or manually selected and/or modified by controller 34 or an operator to affect operation of hydraulic control system 28.

Based on signals received from sensors 70, 72, controller 34 may regulate operation of displacement control valve 58 to maintain a desired discharge pressure P of pump 38 and/or a desired tilt angle α of the swashplate. In particular, controller 34 may receive and compare the signals from sensors 70, 72 to determine a discharge pressure differential ΔP and/or a tilt angle differential Δα. And, if controller 34 determines that ΔP and/or Δα is not about equal to a predetermined value (i.e., within an amount of a desired pressure or tilt angle gradient), controller 34 may generate a response signal directed to displacement control valve 58 that functions to correct ΔP and/or Δα.

The response signal from controller 34 may result in a change in bias current provided by solenoid 66. For example, if ΔP and/or Δα is lower than expected, controller 34 may issue a response signal to solenoid 66 that causes solenoid 66 to change the bias current to move valve element 62 closer toward the second position, thereby causing piston assembly 52 of tilt actuator 46 to retract and increase tilt angle α and, thus, increase the displacement of pump 38. In contrast, if ΔP and/or Δα is higher than expected, controller 34 may issue a response signal to solenoid 66 that causes solenoid 66 to change the bias current to move valve element 62 closer toward the third position, thereby causing piston assembly 52 of tilt actuator 46 to extend and decrease tilt angle α and, thus, decrease the displacement of pump 38. In this manner, leakage may be accurately compensated for, and the desired ΔP and/or Δα may be obtained, which may result in accurate and responsive operation of hydraulic actuators 26.

The response signal may be calculated, determined, and/or estimated by controller 34 with reference to the maps stored in memory and based on input from sensors 70, 72. In particular, controller 34 may be configured to perform an exemplary bias current correction process 400. This process will be described in more detail in the following section.

### INDUSTRIAL APPLICABILITY

The disclosed hydraulic control system may be applicable in any machine where cost and precise regulation of pump output are considerations. The disclosed solution finds particular applicability in hydraulic tool systems, especially hydraulic tool systems for use onboard mobile machines. One skilled in the art will recognize, however, that the disclosed hydraulic control system could be utilized in relation to other machines that may or may not be associated with hydraulically operated tools.

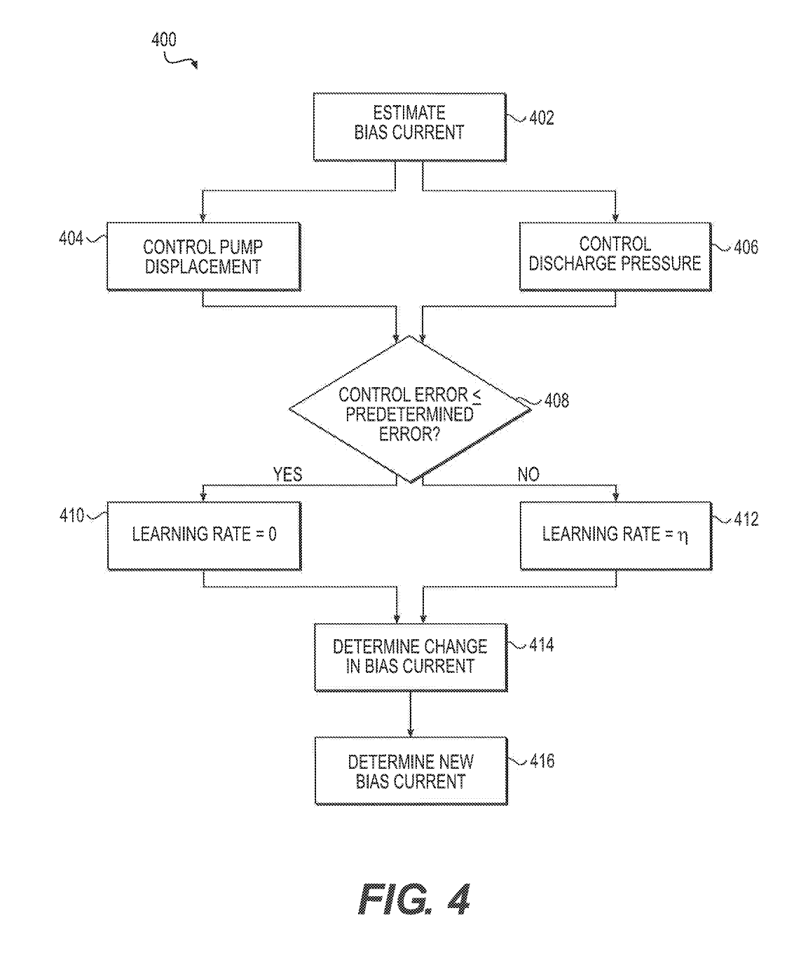

As shown in FIG. 4, controller 34 may be configured to first estimate a bias current based on steady state measurements and/or the maps stored in memory (Step 402). In one embodiment, controller 34 may be configured to determine the effective area Aᵥₐₗᵥₑ of displacement control valve 58 in order to estimate the bias current. The effective area Aᵥₐₗᵥₑ may be calculated based on the following based on equation, Eq. 1 below:

$${A}_{valve} \approx \frac{{C}_{l} {k}_{ppc}}{{C}_{d} \sqrt{2 / ρ} \sqrt{1 - {k}_{ppc}}} \sqrt{P} \approx φ \sqrt{P} \qquad Eq . 1$$

wherein:
   Aᵥₐₗᵥₑ is the effective area of displacement control valve 58;
   Cₗ is a leakage coefficient of pump 38;
   k_{ppc} is a constant based on geometric parameters of pump 38;
   C_{d} is a discharge coefficient of pump 38;
   ρ is a density of the fluid passing through displacement control valve 58;
   P is the discharge pressure of pump 38; and
   φ is a constant determined by factors such as the geometric parameters of pump 38 and fluid passing through pump 38.

Since Cₗ, k_{ppc}, C_{d}, and ρ may all be substantially constant; the equation to find may be simplified to φ\sqrt{P}, such that Aᵥₐₗᵥₑ is directly proportional to \sqrt{P}. Controller 34 may obtain the discharge pressure P via sensor 70, and Aᵥₐₗᵥₑ may be calculated therefrom.

Once Aᵥₐₗᵥₑ has been calculated, controller 34 may determine the bias current i_{bias} required to move valve element 62 a distance against the bias of spring 64 in order to compensate for Aᵥₐₗᵥₑ. Specifically, controller 34 may have stored in memory a map (e.g., an area vs. current curve) that relates known values of Aᵥₐₗᵥₑ to i_{bias}. Using i_{bias}, controller 34 may be configured to calculate a total solenoid current iₛₒₗ based on the follow equation, Eq. 2 below;

$${i}_{sol} ( t ) = {i}_{bias} + \frac{{A}_{c} {L}_{c} {\dot{α}}_{d} + {k}_{ρα} Δα}{{C}_{d} {k}_{c} \sqrt{2 / ρ} \sqrt{P}} \qquad Eq . 2$$

wherein:
   iₛₒₗ(t) is the total solenoid current as a function of time;
   i_{bias} is the bias current required to maintain valve element 62 at the zero-position;
   A_{c} is a cross-sectional area of tilt actuator 46;
   L_{c} is a distance from tilt actuator 46 to a swashplate pivot point;
   Δ\dot{α}_{d} is a desired change in the tilt angle;
   k_{pα} is a control gain associated with the pump displacement;
   Δα is an actual change in the tilt angle;
   C_{d} is the discharge coefficient;
   k_{c} is a control gain of tilt actuator 46;
   ρ is the density of the fluid passing through displacement control valve 58; and
   P is the discharge pressure of pump 38.

Since i_{bias}, A_{c}, L_{c}, Δ\dot{α}_{d}, Δα, k_{pα}, C_{d}, k_{c}, ρ, and P may all be known values, iₛₒₗ(t) may be calculated therefrom. Controller may then cause solenoid 66 to energize based on the calculated solenoid current to control the pump displacement and discharge pressure of pump 38 (Steps 404 and 406). While controlling pump 38, controller 34 may monitor the pump displacement and discharge pressure via sensors 70, 72. The monitored values of pump displacement may then be used to determine a control error associated with the pump displacement and/or discharge pressure. This control error may be compared with a predetermined error (Step 408). For example, if a difference between an actual pump displacement and/or discharge pressure and a desired pump displacement and/or discharge pressure is less than or equal to a predetermined error, then controller 34 may set a learning rate to zero (Step 410) and continue to use the estimated bias current. In other words, since the control error is less than the predetermined error, the bias current does not required correction. Thus, the method may proceed to Step 414 and 416, but the bias current will remain unchanged. However, if the difference is greater than the predetermined error, then the bias current requires correction, and controller 34 may set a learning rate to a constant η (Step 412) to determine a change in bias current (Step 414).

The change in bias current may be determined based on the following equation, Eq. 3 below:

$${i}_{sol} ( t ) = {i}_{bias} + \hat{φ} + \frac{{A}_{c} {L}_{c} Δ {\dot{α}}_{d} + {k}_{ρα} Δα}{{C}_{d} {k}_{c} \sqrt{2 / ρ} \sqrt{P}} \qquad Eq . 3$$

wherein:
   iₛₒₗ(t) is the total solenoid current as a function of time;
   i_{bias} is the bias current required to maintain valve element 62 at the zero-position;
   \hat{φ} is an estimated bias current constant;
   A_{c} is the cross-sectional area of tilt actuator 46;
   L_{c} is the distance from tilt actuator 46 to a swashplate pivot point;
   Δ\dot{α}_{d} is the desired change in the tilt angle;
   k_{pα} is the control gain associated with the pump displacement;
   Δα is the actual change in the tilt angle;
   C_{d} is the discharge coefficient;
   k_{c} is the control gain of tilt actuator 46;
   ρ is the density of the fluid passing through displacement control valve 58; and
   P is the discharge pressure of pump 38.

The difference between Eqs. 2 and 3 is an estimated bias current constant \hat{φ}, which may be used to estimate a change in bias current. For example, as discussed above, when the control error of the pump displacement is greater than the predetermined error, the learning rate is set to the constant 11. Using this constant and values detected by sensors 70, 72, the estimated constant \hat{φ} may be calculated according to the following equation, Eq. 4 below:

{circumflex over (\dot{φ}=−ηΔα\sqrt{P} Eq. 4
wherein;
   η is a constant which determines a rate of adoption (i.e., learning rate);
   Δα is the change in tilt angle of the swashplate; and
   P is a discharge pressure of pump 38.

Controller 34 may be configured to use Eq. 4 above to determine a change in bias current. The change in bias current may be added to or subtracted from the previously estimated bias current to generate a new bias current (Step 416). This corrected bias current may account for inconsistencies due to manufacturing tolerances of displacement control valve 58. Further, the corrected bias current may update the bias current overtime, as opposed to using preset values and maps for estimated in the bias current. As a result, the bias current correction may increase accuracy and response time of pump 38.

In an alternative embodiment, controller 34 may determine the change in bias current based on Eqs. 5 and 6 shown below, instead of Eqs. 3 and 4. Eqs. 5 and 6 may defined in terms of discharge pressure control rather than pump displacement control. In this embodiment, the change in bias current may be determined based on the following equation, Eq. 5 below:

$${i}_{sol} ( t ) = {i}_{bias} + \hat{φ} + \frac{{A}_{c} {L}_{c} Δ {\dot{α}}_{d} + {k}_{pp} Δ P + {k}_{dp} Δ \dot{P}}{{C}_{d} {k}_{c} \sqrt{2 / ρ} \sqrt{P}} \qquad Eq . 5$$

wherein:
   iₛₒₗ(t) is the total solenoid current as a function of time;
   i_{bias} is the bias current required to maintain valve element 62 at the zero-position;
   \hat{φ} is an estimated bias current constant;
   A_{c} is the cross-sectional area of tilt actuator 46;
   L_{c} is the distance from tilt actuator 46 to a swashplate pivot point;
   Δ\dot{α}_{d} is the desired change in the tilt angle;
   kₚₚ is a control gain of the discharge pressure;
   ΔP is an actual change in the discharge pressure;
   k_{dp} is a control gain of a derivative of the discharge pressure;
   Δ\dot{P} is a derivative of the actual change in the discharge pressure;
   C_{d} is the discharge coefficient;
   k_{c} is the control gain of tilt actuator 46;
   ρ is the density of the fluid passing through displacement control valve 58; and
   P is the discharge pressure of pump 38

In this embodiment, the estimated bias current constant \hat{φ} may be calculated based on the following equation, Eq. 6 below:

{circumflex over (\dot{φ}=ηΔP\sqrt{P} Eq. 6
wherein:
   η is a constant which determines a rate of adoption (i.e., learning rate);
   ΔP is the change in discharge pressure; and
   P is a discharge pressure of pump 38.

Thus, the response signal directed from controller 34 to solenoid 66 in response to ΔP and/or Δα having an undesired value may correct a bias current i_{bias}. And, controller 34 may continue to update and direct this bias current to solenoid 66 in response to ΔP and; or Δα. Additionally, in the past, displacement control valve 58 typically required a spring adjuster that adjusts compression of spring 64. However, the bias current correction process 400 discussed above may eliminate a need for the spring adjuster. For example, by accounting for inconsistencies due to manufacturing tolerances, displacement control valve 58 may no longer require the spring adjuster to adjust the compression of spring 64. Thus, displacement control valve 58 may be manufactured without the spring adjuster. By eliminating this part, costs associated with producing and installing the part may be reduced.

As will be apparent, the described method and apparatus may provide accuracy in the control of pump displacement by correcting a bias current of solenoid 66. Bias current correction may help enable responsive and predictable work tool actuation in constant pressure hydraulic systems. Additionally, bias current correction may help eliminate the need for a spring adjuster used with some variable displacement pumps. By reducing the need for the spring adjuster, the described system may reduce cost and the need to manually adjust spring compression.

It will be apparent to those skilled in the art that various modification and variations can be made to the disclosed hydraulic control system, without departing from the scope of the disclosure. Other embodiments of the disclosed hydraulic control system will be apparent to those skilled in the art from consideration of the specification and practice disclosed herein. It is intended that the specification and examples be considered as exemplary only, with the true scope being indicated by the following claims and their equivalents.

What is claimed is:

1. A hydraulic control system, comprising:
a pump configured to pressurize fluid;
a displacement control valve configured to affect displacement of the pump;
a solenoid configured to bias the displacement control valve to a zero position; and
a controller in communication with the solenoid and configured to:
estimate a bias current that biases the displacement control valve to the zero position;
control the displacement control valve based on the bias current;
monitor a pump parameter of the pump;
determine a control error associated with the pump parameter; and
selectively adjust the bias current based on the control error.

2. The hydraulic control system of claim 1, wherein the pump parameter is a displacement of the pump.

3. The hydraulic control system of claim 1, wherein the pump parameter is a discharge pressure of the pump.

4. The hydraulic control system of claim 1, wherein the controller is configured to determine an effective area of the displacement control valve, and the bias current is estimated based on the effective area.

5. The hydraulic control system of claim 4, wherein the bias current is indicative of an amount of current required of the solenoid to overcome the effective area of the displacement control valve.

6. The hydraulic control system of claim 4, wherein the effective area is calculated based on a discharge pressure of the pump.

7. The hydraulic control system of claim 6, further including a sensor located downstream of the pump and configured to monitor the discharge pressure of the pump.

8. The hydraulic control system of claim 1, wherein the controller is configured to make a comparison between the control error and a predetermined error.

9. The hydraulic control system of claim 8, wherein, when the control error is less than or equal to the predetermined error, the controller is configured to set a learning rate to zero and the bias current remains unchanged.

10. The hydraulic control system of claim 8, wherein, when the control error is greater than the predetermined error, the controller is configured to set a learning rate to a constant value and determine a new bias current based on the learning rate.

11. The hydraulic control system of claim 1, further including:
a displacement control device movable to vary the displacement of the pump; and
a tilt actuator configured to move the displacement control device,
wherein the displacement control valve is fluidly connected to activate the tilt actuator.

12. The hydraulic control system of claim 1, wherein the displacement control valve includes a valve element and a fixed spring configured to bias the valve element.

13. A method of controlling fluid flow from a pump, comprising:
estimating a bias current required to control displacement of the pump;
controlling the pump based on the estimated bias current;
monitoring a pump parameter of the pump;
determining a control error associated with the monitored pump parameter; and
selectively adjusting the estimated bias current based on the control error.

14. The method of claim 13, wherein monitoring the pump parameter includes monitoring a displacement of the pump.

15. The method of claim 13, wherein monitoring the pump parameter includes monitoring a discharge pressure of the pump.

16. The method of claim 13, wherein estimating the bias current includes determining an effective valve area that provides a desired flow of fluid to adjust displacement of the pump, and estimating the bias current based on the effective valve area.

17. The method of claim 16, further including calculating the effective valve area based on a discharge pressure of the pump.

18. The method of claim 13, further including comparing the control error with a predetermined error, and wherein selectively adjusting the estimated bias current includes setting a learning rate to zero and not changing the estimated bias current, when the control error is less than or equal to the predetermined error.

19. The method of claim 13, further including comparing the control error with a predetermined error, and wherein selectively adjusting the estimated bias current includes setting a learning rate to a constant value and changing the estimated bias current, when the control error is greater than the predetermined error.

20. A machine, comprising:
a power source;
a pump driven by the power source to pressurize fluid;
a tool;
a hydraulic actuator configured to move the tool;
a displacement control valve configured to affect displacement of the pump;
a solenoid configured to bias the displacement control valve to a zero position; and
a controller in communication with the solenoid and configured to:
estimate a bias current that biases the displacement control valve to the zero position;
control the displacement control valve based on the bias current;
monitor a pump parameter of the pump;
determine a control error associated with the pump parameter;
make a comparison between the control error and a predetermined error; and
selectively adjust the bias current based on the comparison.
